(19) United States
(12) Patent Application Publication
(10) Pub. No.: US 2026/0197683 A1
(43) Pub. Date: Jul. 9, 2026

(54) METHODS AND DEVICES FOR CONFIRMING PROXIMITY OF A DEVICE

(71) Applicant: Telefonaktiebolaget LM Ericsson (publ), Stockholm (SE)

(72) Inventors: Patrik SALMELA, Jorvas (FI); Peter ÖKVIST, Luleå (SE); Tommy ARNGREN, Luleå (SE); Niklas LINDSKOG, Lund (SE); Magnus THURFJELL, Luleå (SE); Daniel BERGSTRÖM, Luleå (SE)

(21) Appl. No.: 19/135,473

(22) PCT Filed: Dec. 14, 2022
(86) PCT No.: PCT/EP2022/085750

§ 371 Date: Jun. 4, 2025

(51) Int. Cl. H04W 24/08

(52) U.S. Cl. CPC H04W 24/08

(57) ABSTRACT

A method is provided for confirming proximity of a second device. The method is performed in a first device, both devices being enabled for wireless communication, used for mutual communication. The method includes establishing measurement capabilities of the second device, obtaining a set of measurement data on local radio characteristics, receiving measurement data from the second device, and confirming the second device to be a device in proximity of the first device if the received measurement data matches the obtained set of measurement data. A method in a second device, devices, computer programs and computer program products are also provided.

### TECHNICAL FIELD

The technology disclosed herein relates generally to the field of wireless communications, and in particular to devices and methods for confirming proximity of devices.

### BACKGROUND

Wireless technology is used for performing a many different acts, such as phone calls, control of automation equipment and access to buildings, to mention just a few examples. Keyless entry to a vehicle also uses wireless communication and comprises sending a radio signal from a remote transmitter (also known as fob) to a control module/receiver in the vehicle. This radio signal is sent as a data stream (typically encrypted) to the vehicle. Other solutions for such keyless entry allow access to the vehicle without having to press a button; instead, doors unlock as you come within a certain distance of the vehicle. In still other solutions, the vehicle unlocks when a door handle is pulled or a trunk opening mechanism is operated, provided that the user has the key in the vicinity of the vehicle, e.g., in the user's pocket.

Relay attacks in various forms well known, where modus operandi for vehicle thieves often comprises steps wherein a first thief, who carries a radio transmitter/receiver, pings a lock system of a vehicle. The device of the first thief thus impersonates the key, and the vehicle locking system responds with a signal intended for the key, which signal the thief's scanner picks up. The first thief relays the picked up signal to a second thief, who is located close to the true key. The vehicle's response signal is then relayed to the true key; the true key responds with a true response sequence to the vehicle signal, which the key cannot know is being relayed. The second thief then relays, via the first thief, the true key response back to the vehicle and the first thief is then able to unlock it.

From this exemplary scenario it is realized that there is a need for improving safety in view of using wireless communication for different tasks, such as, for instance, locking/unlocking doors.

### SUMMARY

An objective of embodiments herein is to address and improve various aspects for use of wireless communication for authentication. A particular objective is to remove or at least reduce risk of relay attacks, where signals are intercepted and used maliciously. Another objective is to ensure that authentication information is indeed a trusted communication between two intended devices. These objectives and others are achieved by the methods, devices, computer programs and computer program products according to the appended independent claims, and by the embodiments according to the dependent claims.

These objectives and others are, in various embodiments, accomplished by ensuring that two or more devices have matching radio characteristics before allowing an action to be executed. The radio characteristics are local and may as such be considered to be rather unique, as “local fingerprints”.

According to a first aspect, a method for confirming proximity of a second device is presented. The method is performed in a first device and both devices are enabled for wireless communication. The method comprises establishing measurement capabilities of the second device; obtaining a set of measurement data on local radio characteristics; receiving measurement data from the second device; and confirming the second device to be a device in proximity of the first device if the received measurement data matches the obtained set of measurement data.

According to a second aspect, a first device is presented, the first device being configured for confirming proximity of a second device, both devices being enabled for wireless communication. The first device is configured to: establish measurement capabilities of the second device; obtain a set of measurement data on local radio characteristics; receive measurement data from the second device; confirm the second device to be a device in proximity of the first device if the received measurement data matches the obtained set of measurement data.

According to a third aspect, there is presented a computer program for confirming proximity of a second device. The computer program comprises computer code which, when run on processing circuitry of a first device, causes the first device to perform a method according to the first aspect.

According to a fourth aspect there is presented a computer program product comprising a computer program according to the third aspect, and a computer readable storage medium on which the computer program is stored.

According to a fifth aspect, a method for performing a trusted interaction with a first device is presented. The method is performed in a second device and both devices are enabled for wireless communication. The method comprises sending, to the first device, a request for performing an action; receiving, from the first device, a request to measure one or more local radio characteristics and in response thereto performing the requested measuring; sending, to the first device, measurement data resulting from the requested measuring; and being enabled or denied to perform the action.

According to a sixth aspect, a second device for performing a trusted interaction with a first device is presented. Both devices are enabled for wireless communication, the second device being configured to send, to the first device, a request for performing an action; receive, from the first device, a request to measure one or more local radio characteristics and in response thereto performing the requested measuring; send, to the first device, measurement data resulting from the requested measuring; and being enabled or denied to perform the action.

According to a seventh aspect, there is presented a computer program for performing a trusted interaction with a first device. The computer program comprises computer code which, when run on processing circuitry of a second device, causes the second device to perform a method according to the fifth aspect.

According to an eight aspect there is presented a computer program product comprising a computer program according to the seventh aspect, and a computer readable storage medium on which the computer program is stored.

Advantageously, these aspects enable a reduced dataset to be established between devices for authentication evaluation based on calibration of respective first and second devices measurement capabilities and derived thresholds.

These aspects provide improvements of authentication between devices by making use of device calibrations and associated dataset reduction thereby enabling a more efficient transmission of authorization data between the involved devices.

In other advantageous aspects, the correlation between reduced signal sequences based on local radio characteristics also allows for estimation of time-of-execution and measurement data capturing alignment constraints that may enable identification of relay attacks.

Advantageously, these aspects are applicable in various scenarios besides vehicle access. The aspects are, for instance, applicable in a first-second device in context of a input/output device in a user-presence defining relation with user-tags, or in any other remote access solution, such as for instance granting (physical) access to a building, for use of an elevator or other access restricted areas.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings.

FIG. 1 is a signalling diagram for signals between a first and a second device according to embodiments.

FIGS. 2 and 3 are signalling diagrams for signals between a first and a second device according to embodiments.

FIG. 4 is a diagram over exemplary signal strengths.

FIG. 5 is a flowchart of various embodiments of a method in a second device.

FIG. 6 is a flowchart of various embodiments of a method in a first device.

FIG. 7 is a schematic diagram showing functional units of a second device according to an embodiment.

FIG. 8 is a schematic diagram showing functional modules of a second device according to an embodiment.

FIG. 9 shows one example of a computer program product comprising computer readable means according to an embodiment.

FIG. 10 is a schematic diagram showing functional units of a first device according to an embodiment.

FIG. 11 is a schematic diagram showing functional modules of a first device according to an embodiment.

FIG. 12 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

Wireless entrance/access solutions are becoming increasingly common in, for instance, real estate and large-scale building scenarios. A wireless building-door-to-key-lock-mechanism may typically be subject to similar relay attacks as for the vehicle scenario described in the background section. Assuming a building door being equivalent to a car door, and the vehicle key fob having its counterpart in a similar building key fob, there may be a similar situation where a non-authorized person can eavesdrop and relay a true signal in order to enter a building.

Some differences may apply between the scenarios, for instance that access cards etc., often use near-field radio solutions with rather short range, and hence that the over-distance relaying attack might be setup somewhat differently. However, the problem with malicious relay is essentially the same. An exemplary scenario is that a building has a public space such as a lobby or a lunch restaurant on the ground floor but also have restricted access to other parts of the building in its vicinity.

In the following, an exemplary system is described comprising a first device, which is exemplified by a vehicle, and a second device, which is exemplified by a key fob, and methods between them. These methods use, for instance, device pairing benefits, data reduction principles, and data protection. However, as has been noted earlier and also exemplified, there are other scenarios outside vehicle access, in which the present teachings are applicable.

Briefly, in the context of herein disclosed device-to-device solution it is determined whether two or more devices have the same, in the present context meaning “at least to a certain degree similar”, radio environment characteristics. If these characteristics fulfill a determined degree of similarity (and possibly other authentication/authorization of a received message/request) is fulfilled, then a first device authorizes a second device to perform a requested action. In the disclosed methods, consideration may also be taken to calibration of respective first and second devices measurement capabilities and thereof derived thresholds, to establish a reduced data set (i.e., reduced set of data derived from device's respective measurement data) to transmit between the devices for authentication evaluation. Suggested embodiments with respect to device calibrations and associated data set reduction may enable more efficient transmission of authorization data between the considered devices. Additionally, the method may also comprise protecting data transmissions between the devices. Further, a suggested correlation also allows for time-of-execution estimation and measurement data capturing alignment constraints that may enable identification of relay attacks.

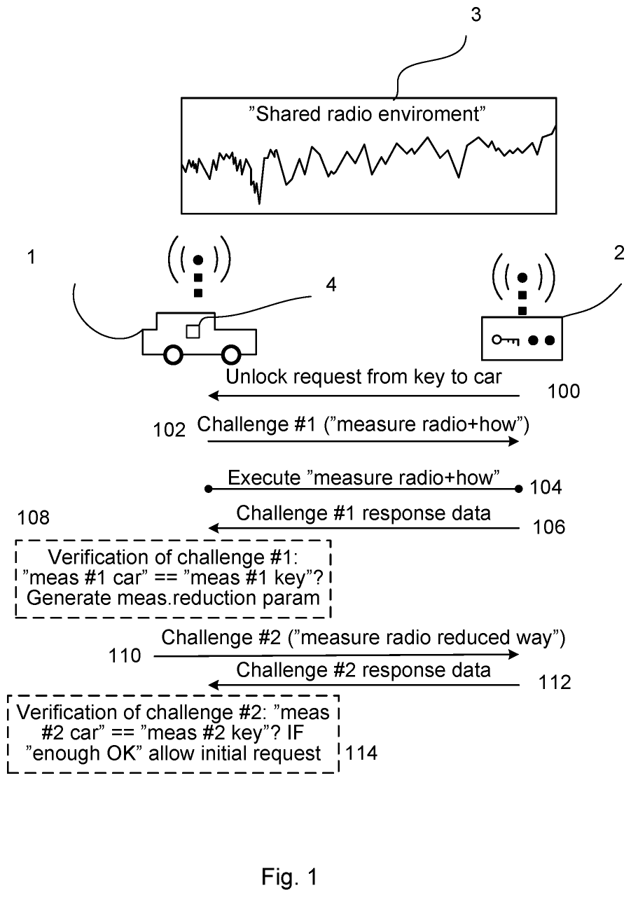

FIG. 1 is a signalling diagram for signals between a first device 1 and a second device 2 according to various embodiments. A respective method 10, 20 in each device is provided that allow the two (or more) devices 1, 2 to determine if they have some degree of matching radio characteristics (much alike fingerprints). The outcome of the determining may, in turn, authorize one or more actions, e.g., to allow a key fob (keyless key) to open and start a car. Above the signaling diagram, an exemplary graph over a parameter in a shared radio environment 3 is shown. The distance between the first and second devices 1, 2 may differ, but since the radio characteristics are similar they are in proximity of each other. The devices 1, 2 are within a distance from each other, where the radio characteristics are essentially the same; for instance, where the difference in the measured radio environment is below a pre-defined threshold.

The first device 1 is exemplified by a vehicle, e.g., a car and the second device 2 is exemplified by a key fob. The first device 1, the car (e.g., a control module in the car), is enabled for wireless communication. It may be enabled for any type of wireless communication by comprising a receiver/transmitter for, for instance, Device-to-Device (D2D) communication. The D2D communication is any direct communication between devices, i.e., without data traffic going through any infrastructure node. Examples of further communication interfaces that may be used by the first and second devices 1, 2 comprise Wi-Fi, various interfaces defined by 3GPP (3rd Generation Partnership Project), such as e.g., interfaces for eMBB (Enhanced Mobile Broadband). Particular examples of Device-to-Device (D2D) interfaces comprise Near Field Communication (NFC), Bluetooth and Radio Frequency Identification (RFID), and particular examples of non-D2D comprise Long Range Radio (LoRa), WiFi and communications over cellular networks.

The car 1 is thus enabled to receive and transmit signals from/to the key fob 2. The car 1 is further able to receive and record a radio signal and associated attributes related to total received power, for instance by comprising one or more of: radio receiver, radio unit, remote radio unit, a base band unit (BBU), antenna unit etc. as is known in the art.

FIG. 1 illustrates a basic exemplary embodiment. An optional step of the key fob 2 initiating the session is that the key fob 2 sends 101 a request for an action to the car 1. It is noted that the session may be initiated in various different ways. For instance, the session may be triggered (initiated) by a user pulling a handle of her car door. The action may, for example, be to unlock a door lock of the car 1. Upon receiving the request, the car 1 (or rather some electronic component in the car 1, for instance, a programmable logic device, but for simplicity “car” is used as communicating part) sends 102 a first challenge to the key fob 2. The challenge may comprise instructions to measure one or more parameters of the surrounding radio environment 3, and instructions on how to do the measuring. Next, both the car 1 and the key fob 2 executes 104 the measurements. The key fob 2 responds 106 to the first challenge by sending non-processed measurement data associated with a first data collection session. The car 1 receives the response to the first challenge and verifies, box 108, the response by comparing the response with its own results. Examples on data to measure comprise noise floor level, dynamic ranges (e.g., noise floor to peak level), peak-power (e.g., signal peaks over x dB over noise floor), time resolution of signal peaks etc.

If the verification is positive, the car 1 generates, still in box 108, a second challenge comprising instructions to measure a reduced set of parameters. This set of parameters may be based on the previous data processing. In such reduced set of parameters, both devices 1, 2 measure the agreed-upon radio environment parameters, but only a reduced set of these parameters are then stored for verification. Thus, the car 1 compares only the reduced set of measurement data with the correspondingly reduced number of measurement data it receives from the key fob 2. In various embodiments, the car 1 may associate an identifier with the reduced set of parameters. This is advantageous in that the car 1 is then enabled to thereafter indicate the reduction set by using only the parameter instead of sending the full reduction set to the key fob 2, thus rendering the method more efficient in view of increased accuracy while not compromising on security since frequencies are selected such that they can be reliably measured by both parties. Further advantages comprise, for instance, reduced signalling payload between the car 1 and the fey fob 2, speed of process, battery capacity, etc. Such identifier may be sent to the key fob 2 in the second challenge. The car 1 sends 110 the second challenge, which is received by the key fob 2. The key fob 2 executes the instructions and responds 112 to the second challenge by providing the requested data to the car 1. In case of using the described identifier, the key fob 2 preferably stores the identifier for future use. The car 1 performs 114 the same measuring according to the reduced set of parameters and compares the result of the second challenge to the results received from the key fob 2. If there is a sufficient agreement of the two results, the initial request for an action is allowed, e.g., the car door is unlocked.

The measuring of parameters of the radio environment 3 that the car 1 requests the key fob 2 to perform as the second challenge may, for instance, comprise one or more of: scanning an indicated radio interface/access, indicated start time after signal reception, measuring during a specified time duration, using a specified time resolution, including the requested measurement results into a secure (e.g., signed) response, etc. A particular example is to request the key fob 2 to execute measurement descriptions of the determined data reduction scheme according to related processing thresholds received from the car 1. The key fob 2 may be configured to apply thresholding, for instance, in terms of:

$$\begin{matrix}[ data sequence entries ] > threshold A = 1 \\ [ data sequence entries ] < threshold a = 0 \\ or \\ ( ( [ data sequence entries ] > thr\_A ) AND ( peak\_power > thr\_B ) ) = 1 \\ or \\ ( ( [ data sequence entries ] > thr\_A ) AND ( peak\_power > thr\_B ) AND \\ ( power\_measure > noise\_level \_thr ) ) = 1\end{matrix}$$

where a power measure may include peak power, or some average, median, or other distribution measure (percentile), etc. Noise level may be of interest as there may be a high peak power but at the same time a high noise, adding a “over noise” measure may typically also include use of a Signal-to-Noise Ratio (SNR)-measure.

The car 1 comprises a processing unit 4 for processing measurement data obtained from the key fob 2. The processing unit 4 may be configured to, based on information in the received reduced signal data (received at arrow 106, FIG. 1), compare a first set of vehicle-measured reduced data with a second set of reduced data received from the key fob 2 (i.e., both sets reduced according to determined joint principles). The comparisons may, e.g., comprise amount of reduced signal sequence correlation over entire sequence, amount of reduced signal sequence correlation for a selected estimated overlapping signal sequence segment, etc.

In some embodiments, it may suffice to compare the non-reduced measurement data. Such comparisons may, for instance, comprise comparing predefined signal attributes in a first set of vehicle-measured data with a second data set from key fob, e.g., in view of amount of signal strength correlation, amount of signal strength correlation for a selected estimated overlapping signal segment, correlation of channel angular spread, etc.

The processing unit 4 of the car 1 may be arranged to determine that the key fob 2 is indeed a valid one, based at least on it being in proximity. This can be implemented as requirements that there is sufficiently high number of similarities between the measurement data. The requirement may, for instance, comprise determining similarity of the first and second reduced signal sequences to be above a threshold. If the threshold is met, then the processing unit 4 determines that the key fob 2 is indeed the valid key fob. Since it has essentially same radio environment measurements as the car 1, it must be close in physical proximity. Thereafter, the processing unit 4 allows the requested action to be made, and proceeds further with the requested action, which may, for instance, be to unlock a door of the car 1, to activate the car 1 or to start the car 1. It is noted that for the key fob 2 to be a valid key fob 2, it may, and typically do, need to also perform an authentication based on credential that it has, e.g., used for creating a digital signature of its response. Typically, both validations are needed since it is not enough to only prove that the key fob 2 has an approximate location close enough to the car 1. However, such authentications are well known as such, and therefore not illustrated in FIG. 1.

It is further noted that “close enough” may depend on various circumstances, for instance, the respective range of the first and second devices 1, 2, the communication interfaces used by the first and second devices 1, 2, the device's respective transmit power, operating frequencies, radio access constellation (coding, modulation etc.), radio receiver performance, transmission/reception antenna characteristics (e.g., directional and/or omni antennas, multi-antennas), radio interface interference levels (i.e., relating to SINR and not only SNR), weather conditions (rain, humidity etc.), environment foliage (leaves during spring/summer), building environment/topology, e.g. open areas, rural height rise, e.g. parking area in open regions or the parking area being interleaved in street environment, outdoor area or indoors of respective vehicle/key fob, amount of radio interface activity providing “randomness” to the interference, user behaviour, e.g., key fob being handheld or in pocket/bag.

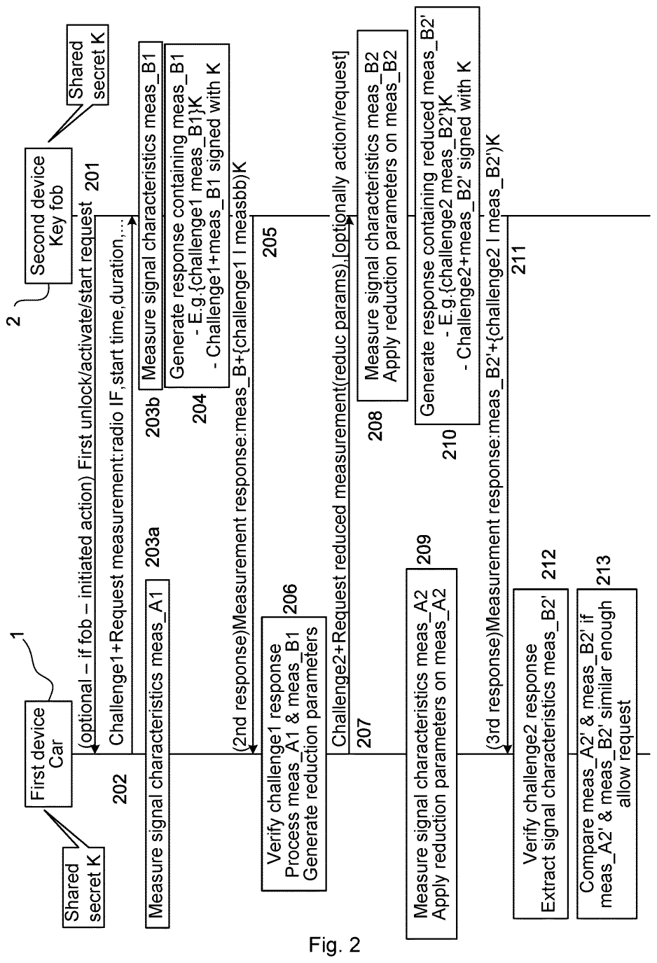

FIG. 2 is a signalling diagram for signals between a first device 1 and a second device 2 according to embodiments.

Step 201: This is an optional step, which should be performed if it is the second device (again exemplified by a key fob) that initiates the exchange by requesting access to the first device (again exemplified by a car). In this optional step, the key fob 2 sends an access request to the car 1.

Step 202: The car 1 generates a first challenge (e.g., a random value) and sends a request to the key fob 2, for use by the car 1 in an authentication evaluation. The request comprises a first challenge and a request to perform local radio measurement. The request also comprises information on parameters to use during the radio measurement. Examples on such parameters have already been given in relation to FIG. 1, but may, for instance, comprise a point in time when to start measuring, time when to stop measuring, time period during which to record the measurements (wherein the two first parameter gives the third, or the first and third gives the second), frequency areas to measure etc. One or more such parameters may be used. When the reduced parameters have already been agreed on between the key fob 2 and the car 1, an identification of the reduction parameters may be sent in this message.

Steps 203a, 203b: Both the car 1 and the key fob 2 perform the radio measurement based on the parameters sent in step 202 from the car 1 to the key fob 2. The measurements made by both devices 1, 2 give respective signal measurement characteristics: meas_A1 for the car 1 and meas_B1 for the key fob 2, respectively.

Step 204: The key fob 2 generates a response message to the request received in step 202. The response message comprises the result of the measurements performed by the key fob 2, i.e., meas_B1, and a response to the first challenge received in step 202. An example on how the response may be generated is that the key fob 2 creates a digital signature, a hash-based Message Authentication Code (HMAC) or a Message Authentication Code (MAC), over the first challenge and/or the measurement result (meas_B1). This may be done by using, for instance, a shared secret K known to both the car 1 and the key fob 2. Alternatively, if using asymmetric keys, the key fob 2 may use its private key for generating the signature over the data.

In further embodiments, or in addition to the described embodiments, the processing unit 4 of the car 1 may further be arranged to verify the second response and the authentication response carried in it by using the shared secret K. The car 1 may verify that the response has indeed been generated by the key fob 2, e.g., by verifying a digital signature by using the public key of the key fob 2, which is generated using the private key of the key fob 2.

Step 205: The key fob 2 sends the generate response message to the car 1. This response comprises the measurement result, meas_B1, and the signature over the first challenge and/or the measurement result. In some embodiments, the first challenge may also be echoed to the car 1 in this response message.

Step 206: The car 1 verifies the digital signature or the HMAC or a MAC received in the response message, either using the shared secret K or using the public key of the key fob 2. Even if the first challenge was not included in the reply, the car 1 still needs to know the first challenge to be able to verify the response to the first challenge it sent to the key fob 2 and may use that knowledge for verifying the digital signature, HMAC or MAC. The car 1 explicitly and/or implicitly verifies that the key fob 2 has used the challenge provide by the car 1 in step 202 when generating the signature, HMAC or MAC. An explicit verification may, for instance, comprise verifying that the challenge, that was echoed back by the key fob, matches the first challenge sent to the key fob. The implicit verification may, for instance, comprise verifying the digital signature, HMAC or MAC using the first challenge, when the first challenge has been covered by a signature/HMAC/MAC.

The car 1 processes its own measurement result, meas_A1, and the measurement result, meas_B1, received from the key fob 2. Such measurement result may typically comprise a time vector of signal strength (energy) data, such as Received Signal Strength Indicator (RSSI), Reference Signal Received Power (RSRP), or the like, the signal strength data being selected such as to be relevant for the considered radio access type. Based on the processing, the car 1 generates reduction parameters that typically describes how the key fob 2 may pre-process data in order to reduce amount of measurement data to be transmitted in later responses. For instance, such as measurement data thresholding, e.g. {[meas_data_entries]>thresholdA=1; [meas:_data_entries]<thresholdA=0}, or {[meas_data entries]>thr_A) AND (peak_power>thr_B))=1}, or (([data sequence entries]>thr_A) AND (peak_power>thr_B) AND (power_measure>noise_level_thr))=1 etc.).

Step 207: The car 1 sends a second challenge to the key fob 2, the message also comprising the generated reduction parameters and optionally an identifier for the reduction parameters (described earlier), and optionally the action/request. The action/request may comprise advanced scenarios, for instance, where the key fob 2 still does some form of access control by verifying that the action the car 1 is about to execute is what the key fob 2 intended (or will allow) the car 1 to do. The actual challenge value may be the same as sent in the first challenge or a new challenge value.

Step 208 and Step 209: The car 1 and the key fob 2 perform a second set of measurements based on the same parameters as used before, resulting in meas_A2 and meas_B2, respectively. The car 1 and the key fob 2 apply the reduction parameters on the respective new measurements, resulting in meas_A2′ and meas_B2′. For example, that car applies the same data reduction scheme as required towards key, and then compares similarity of the reduced data sequences; typically, if a basic thresholding has been required towards the key fob 2, the car 1 may compare two [001001010]-alike vectors compared to a previous comparison of two vectors of decimal and/or integer numbers.

Step 210: The key fob 2 generates a similar response to the second challenge as it did to the first challenge (in step 204). In this response the second challenge is used instead of the first challenge, and meas_B2′ is used as the measurement value in the response to the car 1.

Step 211: The key fob 2 sends a response message (possibly third response) to the car 1 based on meas_B2′.

Step 212: The car 1 verifies the response message in a similar way as it did in step 206.

Step 213: The car 1 extracts meas_B2′ from the response received from the key fob 2. The car 1 compares meas_A2′ and meas_B2′ to verify whether they have been generated in a similar radio environment. If the measurements are similar enough it means that they have most likely been measured reasonably close to each other, and thereby it is proven that the key fob 2 is indeed close to the car 1. Using the shared secret K, or asymmetric keys of the key fob 2, for generating the responses it is proven that the key fob 2 is the device it claims to be, i.e., it is authenticated and may thus be authorized to perform requested actions. It is further noted that the car 1 may also authenticate towards the key fob 2 in a similar manner by utilizing the shared secret K or its own private key.

FIG. 3 is a signalling diagram for signals between a first and a second device according to embodiments. FIG. 3 illustrates an exemplary, reduced or even optimized flow for scenarios where the car 1 and the key fob 2 already have the required reduction parameters available from a previous session and which can be re-used; that is, only certain of the measured parameter values are sent to the car 1. As long as the car 1 and the key fob 2 are enabled to use the same reduction parameter, such re-use is possible. At some instances, the reduction parameters may need to be updated, for instance if the car 1 and/or key fob 2 have/has been updated in terms of, for instance, new firmware, battery change etc. As another example on when the reduction parameters may need to be updated is temperature; for instance, during winter the key fob 2 may risk being frozen and running on low battery voltage. As still another example, the car 1 (e.g., the processing unit 4 thereof) may be arranged to evaluate the compliance of the key fob 2. The car 1 may thereby detect, over time, whether a behavior of the key fob 2 is still fulfilling required rules/demands. The key fob 2 may, for instance, have a drift towards non-compliance over time, and the car 1 may establish that the key fob 2 is indeed inside required measures or that it has drifted outside set requirements. In the latter case, the reduction parameters may need to be derived anew. The reductio parameters may be updated, for instance by doing the regular (and also longer) version, as describer earlier, i.e., wherein the car 1 provides, to the key fob2, the reduction parameters to use and an identification of them.

In a scenario, wherein the reduction parameters can be re-used, the key fob 2 may, in the initial request message, also send an identifier for the reduction parameters that it has (reduction_ID). If the car 1 knows this set of reduction parameters and allows the key fob 2 to re-use them, the car 1 may respond with a request for reduced measurements based on those reduction parameters. In this case the car 1 and the key fob 2 only do the measurement step resulting in reduced measurement values meas_X1′ and do not need to perform the extra measurement step to generated measurements needed to generate the reduction parameters.

Step 301: This is an optional step (compare step 201 of FIG. 2), which should be performed if it is the second device 2 (again exemplified by a key fob) that initiates the exchange by requesting access to the first device (again exemplified by a car). In this optional step, the key fob 2 sends an access request to the car 1. The car 1 may, as noted earlier, generate a first challenge (e.g., a random value) and send a request to the key fob 2, for use by the car 1 in an authentication evaluation.

Steps 302a and 302b: In these steps the car 1 sends the first challenge and request for reduced measurements data directly, if it is known that the key fob 2 already have the needed reduction parameters and may use them. As described earlier, it suffices to include an identification for the reduction parameters in the request.

Step 303a, 303b: If the key fob 2 does not have the reduction parameters, then this step has to be done. That is, the car 1 needs to send a request with a generated first challenge, a request to perform the local radio measurements, as well as which parameters to use during the radio measurements (compare to Step 202).

Steps 304 and 305: the car 1 and the key fob 2, respectively, perform the measuring required in respective previous steps 302, 303.

Step 306: If reduced set of parameters is available and allowed by the car 1, then they are to be applied by the key fob 2 on meas_B1. If such parameters are not available, then steps corresponding to Steps 203a, 203b and Steps 204-206 are performed.

Step 307: The key fob 2 generates a response containing the reduced meas_B1′. An example on this is: {challenge1 meas_B1′} K-Challenge1+meas_B1′ signed/MACed with K.

Step 308: The key fob 2 sends the generated reduced measurements data meas_B1′ and the generated response to the first challenge. For response, e.g., the shared secret K may be used for verifying that the response has indeed been generated by the key fob 2, e.g., by verifying a digital signature/MAC generated using the shared secret K. If asymmetric credentials are used, the verification is made using public key.

Step 309: The car 1 verifies that the response received from the key fob 2 is indeed valid, i.e., that the key fob 2 is an authorized device. The car 1 also extracts the signal characteristic meas_B1′.

Step 310: The car 1 locates the reduced parameters based on a reduction ID and applies them on its own value, Meas_A1.

Step 311: The car 1 finally compares meas_A1′ and meas_B1′ and if they are similar enough, then the car 1 will allow the request received from the key fob 2.

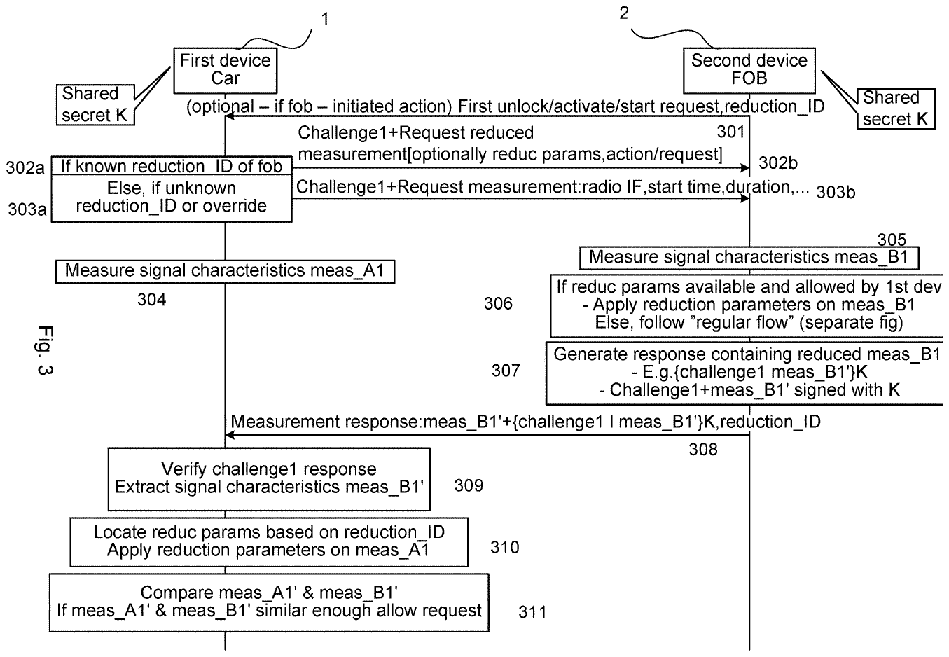

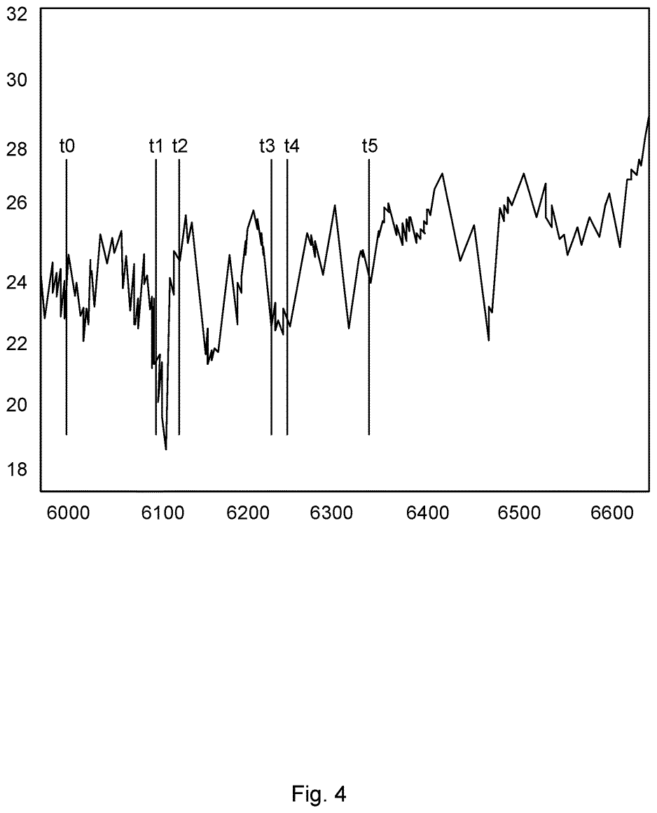

FIG. 4 is a diagram over exemplary signal strengths. In one example, the car 1 initiates a verification a communication session with the key fob 2 at time step 6000 in FIG. 4. At this timestep 6000, at time to, the car 1 starts recording the radio spectrum. One second later (for example), at time t1, which in this example is 100 time steps, the car 1 initiates sending a request for verification to the key fob 2. A signal transmission over the air is assumed to take maximum 167 μs. This is in 10-5 range of time steps, and the signal transmission time is therefore ignored. This key processing time information has been previously configured or exchanged between the car 1 and the key fob 2. That is, before starting the signal measurement there is e.g., 250 ms (25 time steps) waiting time.

At time t2 the key fob 2 starts measuring for a duration of e.g., 1000 ms (100 time steps, although any other duration may be selected); that is; until time t3 after which it processes (e.g., reduces) the measurements and wraps up data for e.g., 250 ms (25 time steps). The key fob 2 then starts a pause, t4, before transmitting data back to the car 1. The pause may, for example, be 1000 ms (100 steps) after which the key fob 2 transmits the measurement data to the car 1 at time t5. If further assuming a vanishingly small delay from signal over-the-air transmission, the car 1 will receive the sent measurement data packet at time t5. The car 1 then stops its own measuring.

The car 1 may, for instance, execute the following:
[C, lags]=xcorr(meas_A, meas_B), in that
   where
meas_A=car_data(to, t5)
meas_B=key_data(t2, t3),
   where car_data and key_data may be reduced_car_data and reduced_key_data, respectively.

Given that the car 1 and the key fob 2 are relatively adjacent to each other in the radio environment terms, the car 1 (or rather processing unity therein) will detect a highest data correlation between what the key fob 2 collected and reported and the car's 1 ground truth in the middle of car's own data set.

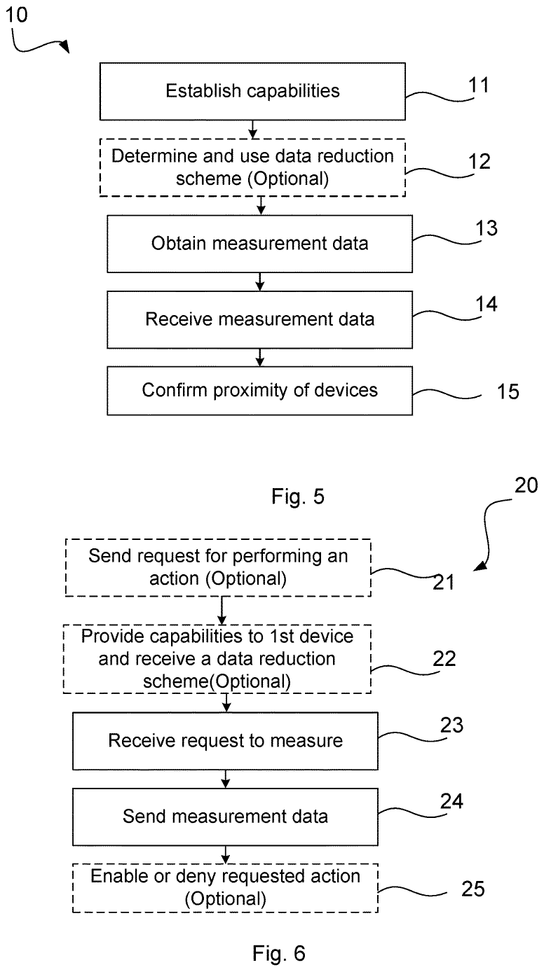

FIG. 5 is a flowchart of various embodiments of a method in a first device 1, which may, for instance, be a car, a vehicle, a vessel, an elevator, a safety box, building entrance with any type of access solution, etc. Optional steps are indicated by boxes with dashed lines.

The method 10 is performed in first device 1 and may be used for confirming proximity of a second device 2. Both devices 1, 2 are enabled for wireless communication, which is used for their mutual communication. The method 10 comprises establishing 11 measurement capabilities of the second device 2. This may be done by an initial capability handshake signalling. By means of this feature the two device's measurement capabilities can be calibrated and thresholds derived thereof.

The method 10 comprises obtaining 13 a set of measurement data on local radio characteristics. Both devices 1, 2 obtains such set of measurement data, and some examples on such local radio characteristics comprise one or more of: noise floor levels, dynamic range of noise floor to peak level, peak-power and time resolution of signal peaks.

The method 10 comprises receiving 14 measurement data from the second device 2.

The method 10 comprises confirming 15 the second device 2 to be a device in proximity of the first device 1 if the received measurement data matches the obtained set of measurement data.

The method 10 provides a reliable way to ensure that the second device 2 indeed is a device authorized to request an action, such as requesting a car to open a door lock, requesting access to a building, or requesting an elevator to stop at an otherwise forbidden floor. Malicious relay attacks are thereby efficiently prevented.

In an embodiment, the method 10 comprises, prior to the obtaining 13, the step of determining 12 a data reduction scheme based on the established measurement capabilities, and the step of obtaining 13 a set of measurement data comprises using the determined data reduction scheme on the measurement data on local radio characteristics. Such embodiments, using the data reduction scheme, are advantageous in that it may reduce the amount of signalling. This in turn is advantageous e.g., since battery capacity of wireless devices typically is a scarce resource. In the FIG. 5, the box 12 is drawn with dashed lines to indicate that it is an optional step.

In an embodiment, dependent on the above embodiment, the confirming 15 comprises comparing the reduced measurement data received from the second device 2 with reduced measurement data obtained in the first device 1 and confirming the second device 2 to be in proximity of the first device 1 if the received reduced measurement data matches the reduced measurement data obtained in the first device 1.

In various embodiments, the reduced measurement data from the second device 2 comprises results of corresponding measurements as made by the first device 1 to obtain the set of data.

In various embodiments, the method 10 is initiated by receiving, from the second device 2 a request to perform an action. In a particular such embodiment, the method 10 comprises determining the second device 2 to be authorized to perform the requested action when confirmed to be in proximity of the first device 1.

In various embodiments, the received measurement data matches the obtained set of data when at least one set threshold is met.

In various embodiments, the method 10 comprises performing 17 an action in response to confirming the second device 2 to being in proximity.

In various embodiments, the above-mentioned action comprises altering a state of a resource from a first state to a second state. An example of this is that the resource is a lock and one of the first and second states is a locked state and the other an unlocked state. Another example is that the resource is a device and one of the first and second states is a moving state and the other is a non-moving state.

In various embodiments, the mutual communication is based on direct device-to-device, D2D communication and/or communication via one or more proxy devices in the mutual communication.

In various embodiments, the wireless communication comprises one or more of: device-to-device, D2D, communication, cellular communication, uplink/downlink Enhanced Mobile Broadband, UL/DL eMBB.

A first device 1 for confirming proximity of a second device 2 is also provided. Both devices 1, 2 are enabled for wireless device-to-device, D2D, communication, which is used for their mutual communication. The first device 1 is configured to perform any or all embodiments of the method 20 that has been described.

The first device is configured to establish measurement capabilities of the second device 2; to obtain a set of measurement data on local radio characteristics, to receive measurement data from the second device 2; and to confirm the second device 2 to be a device in proximity of the first device 1 if the received measurement data matches the obtained set of measurement data.

In an embodiment, the first device 1 is configured to, prior to the obtaining, determine a data reduction scheme based on the established measurement capabilities; and to obtain a set of measurement data comprises using the determined data reduction scheme on the measurement data on local radio characteristics.

In an embodiment, the first device 1 is configured to compare reduced measurement data received from the second device 2 with reduced measurement data obtained in the first device; and to confirm the second device 2 to be in proximity of the first device 1 if the received reduced measurement data matches the reduced measurement data obtained in the first device 1.

In various embodiments, the first device 1 is configured for mutual communication selected among one or more of: direct device-to-device, D2D communication and communication via one or more proxy devices in the mutual communication.

In various embodiments, the wireless communication comprises one or more of: device-to-device, D2D, sidelink communication, cellular communication, uplink/downlink Enhanced Mobile Broadband, UL/DL eMBB.

FIG. 6 is a flowchart of various embodiments of a method in a second device 2, for instance a key fob 2. Optional steps are indicated by boxes with dashed lines.

A method 20 performed by a second device 2 is also provided. The second device 2 may, for instance, comprise a key fob. The method 20 is used for performing a trusted interaction with a first device 1 and performed in the second device 2. Both devices 1, 2 are enabled for wireless communication, which is used for mutual communication.

The method 20 is provided for performing a trusted interaction with a first device 1, the method 20 is performed in a second device 2. Both devices 1, 2 are enabled for wireless communication, which is used for their mutual communication.

The method 20 comprises receiving 23, from the first device 1, a request to measure one or more local radio characteristics and in response thereto performing the requested measuring. Several examples on such local radio characteristics have been given earlier, and both devices 1, 2 preferably measures the same radio characteristics.

The method 20 comprises sending 24, to the first device 1, measurement data resulting from the requested measuring.

In an embodiment, the method 20 comprises, prior to receiving 23 the request to measure, providing 22 measurement capabilities to the first device 1, and receiving in response a data reduction scheme to be used on the measurement data on local radio characteristics.

In various embodiments, the method 20 comprises, prior to receiving 23 the request to measure, sending 21, to the first device 1, a request for performing an action, and after sending 24 the measurement data being enabled 25 or denied performing the action. As noted earlier, such action may, for instance, be to unlock a lock a door or open a closed door or close an opened door.

In the method 20 the second device 2 is then enabled 25 or denied to perform the requested action. It may be enabled to do the requested action if the first device 1 determines the difference of their local radio characteristics to be below a certain threshold, e.g., that their respective measurement values are within certain determined intervals. The second device 2 may, for instance, be denied performing the requested action simply by nothing happening. That is, there does not need to be any active measures taken by the first device 1 nor by the second device 2.

Correspondingly, an enablement may comprise that the user of the second device 2 finds the action to be performed, e.g., a door being unlocked or opened.

In various embodiments, the method 20 comprises receiving from the first device 1, instructions to provide a time stamp of the measurement data.

In various embodiments, the mutual communication is based on direct device-to-device, D2D communication and/or communication via one or more proxy devices in the mutual communication.

In various embodiments, the wireless communication comprises one or more of: device-to-device, D2D, communication, cellular communication, uplink/downlink Enhanced Mobile Broadband, UL/DL eMBB.

The described methods 10, 20 provide several advantages. For instance, the methods 10, 20 enable the establishing of a reduced data set for transmission between devices to be used in authentication evaluation. The establishing is, in various embodiments, based on calibration of respective first and second devices measurement capabilities and derived thresholds.

Suggested improvements of authentication making use of device calibrations and associated data set reduction may enabled more efficient transmission of auth data between considered devices.

In a further embodiment, the suggested correlation method also allows for time-of-execution estimation and measurement data capturing alignment constraints that may enable identification of relay attacks.

A second device 2 for performing a trusted interaction with a first device 1 is also provided. Both devices 1, 2 are enabled for wireless communication, which is used for their mutual communication. The second device 2 is configured to perform any or all embodiments of the method 20 that has been described.

The second device 2 is configured to receive from the first device 1, a request to measure one or more local radio characteristics and in response thereto performing the requested measuring; to send, to the first device 1, measurement data resulting from the requested measuring.

In an embodiment, the second device 2 is configured to, prior to receiving the request to measure, provide measurement capabilities to the first device 1, and receiving in response a data reduction scheme to be used on the measurement data on local radio characteristics.

In various embodiments, the second device 2 is configured to, prior to receiving the request to measure, sending, to the first device 1, a request for performing an action, and after sending 24 the measurement data being enabled 25 or denied performing the action.

In various embodiments, the second device 2 is configured to use direct device-to-device, D2D communication and/or communication via one or more proxy devices in the mutual communication.

In various embodiments, the second device 2 is configured to use one or more of: device-to-device, D2D, communication, cellular communication, uplink/downlink Enhanced Mobile Broadband, UL/DL eMBB.

In other embodiments, the second device 2 is configured to receive from the first device 1, instructions to provide a time stamp of the measurement data.

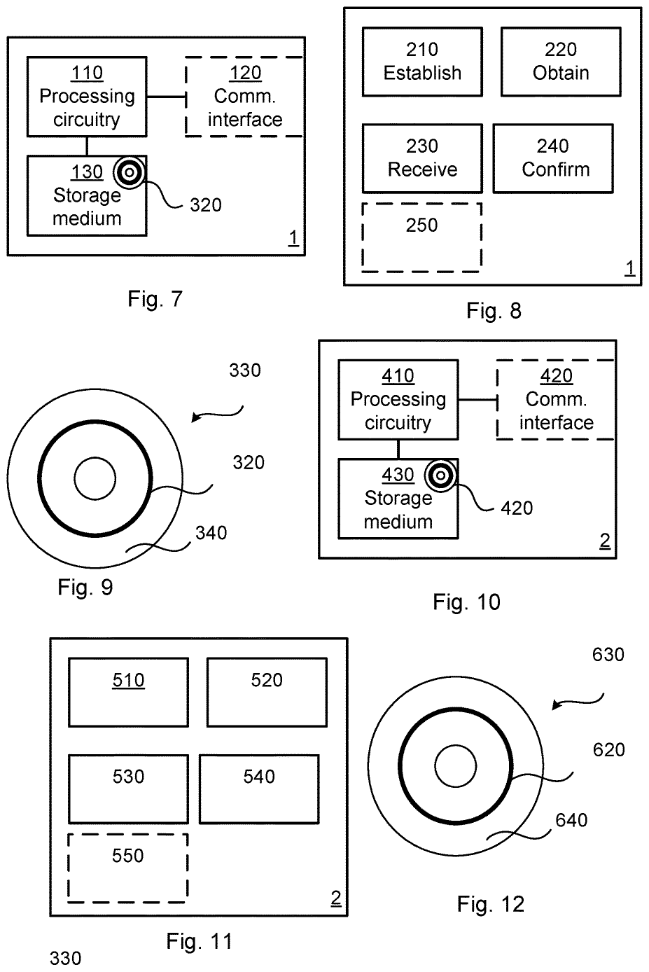

FIG. 7 is a schematic diagram showing functional units of a first device 1, e.g., a module in a car 1 according to an embodiment. FIG. 7 schematically illustrates, in terms of a number of functional units, the components of a first device 1 according to an embodiment. Processing circuitry 110 is provided using any combination of one or more of a suitable central processing unit (CPU), multiprocessor, microcontroller, digital signal processor (DSP), etc., capable of executing software instructions stored in a computer program product 330 (as in FIG. 9) e.g., in the form of a storage medium 130. The processing circuitry 110 may further be provided as at least one application specific integrated circuit (ASIC), or field programmable gate array (FPGA).

Particularly, the processing circuitry 110 is configured to cause the first device 1 to perform a set of operations, or actions, as disclosed herein. For example, the storage medium 130 may store the set of operations, and the processing circuitry 110 may be configured to retrieve the set of operations from the storage medium 130 to cause the first device 1 to perform the set of operations. The set of operations may be provided as a set of executable instructions. The processing circuitry 110 is thereby arranged to execute methods as herein disclosed.

The storage medium 130 may also comprise persistent storage, which, for example, can be any single one or combination of magnetic memory, optical memory, solid state memory or even remotely mounted memory.

The first device 1 may further comprise a communications interface 120 for communications with other entities, functions, nodes, and devices, over suitable interfaces, and in particular for communication with a second device 2 as has been described herein. As such the communications interface 120 may comprise one or more transmitters and receivers, comprising analogue and digital components.

The processing circuitry 110 controls the general operation of the first device 1 e.g., by sending data and control signals to the communications interface 120 and the storage medium 130, by receiving data and reports from the communications interface 120, and by retrieving data and instructions from the storage medium 130. Other components, as well as the related functionality, of the first device 1 are omitted in order not to obscure the concepts presented herein.

FIG. 8 is a schematic diagram showing functional modules of a first device 1 according to an embodiment. FIG. 8 schematically illustrates, in terms of a number of functional modules, the components of a first device 1 according to an embodiment. The first device 1 illustrated in FIG. 8 comprises a number of functional modules; an establish module 210 configured to establish measurement capabilities of a second device 2; an obtain measurement data module 220 configured to obtain measurement data; a receive module 230 configured receive measurement data, and a confirm module 240 for confirming proximity of devices. The device 20 of FIG. 8 may further comprise a number of optional functional modules, such as for instance a determine module 250 configured to determine and use a data reduction scheme. In general terms, each functional module 210-250 may be implemented in hardware or in software. Preferably, one or more or all functional modules 210-250 may be implemented by the processing circuitry 110, possibly in cooperation with the communications interface 120 and the storage medium 130. The processing circuitry 110 may thus be arranged to from the storage medium 130 fetch instructions as provided by a functional module 210-250 and to execute these instructions, thereby performing any actions of the first device 1 as disclosed herein.

FIG. 9 shows one example of a computer program product comprising computer readable means according to an embodiment. FIG. 9 shows one example of a computer program product 330 comprising computer readable means 340 according to an embodiment. On this computer readable means 340, a computer program 320 can be stored, which computer program 320 can cause the processing circuitry 110 and thereto operatively coupled entities and devices, such as the communications interface 120 and the storage medium 130, to execute methods according to embodiments described herein. The computer program 320 and/or computer program product 330 may thus provide means for performing any actions of the second device as herein disclosed.

In the example of FIG. 9, the computer program product 330 is illustrated as an optical disc, such as a CD (compact disc) or a DVD (digital versatile disc) or a Blu-Ray disc. The computer program product 330 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 330.

FIG. 10 is a schematic diagram showing functional units of a second device 2 according to an embodiment. FIG. 10 schematically illustrates, in terms of a number of functional units, the components of a second device 2 according to an embodiment. Processing circuitry 410 is provided using any combination of one or more of a suitable central processing unit (CPU), multiprocessor, microcontroller, digital signal processor (DSP), etc., capable of executing software instructions stored in a computer program product 620 (as in FIG. 12) e.g., in the form of a storage medium 430. The processing circuitry 410 may further be provided as at least one application specific integrated circuit (ASIC), or field programmable gate array (FPGA).

Particularly, the processing circuitry 410 is configured to cause the second device 2 to perform a set of operations, or actions, as disclosed herein. For example, the storage medium 430 may store the set of operations, and the processing circuitry 410 may be configured to retrieve the set of operations from the storage medium 430 to cause the second device 2 to perform the set of operations. The set of operations may be provided as a set of executable instructions. The processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The second device 2 may further comprise a communications interface 420 for communications with other entities, functions, nodes, and devices, over suitable interfaces, and in particular for communication with a first device 1 as has been described herein. As such the communications interface 420 may comprise one or more transmitters and receivers, comprising analogue and digital components.

The processing circuitry 410 controls the general operation of the second device 2 e.g., by sending data and control signals to the communications interface 420 and the storage medium 430, by receiving data and reports from the communications interface 420, and by retrieving data and instructions from the storage medium 430. Other components, as well as the related functionality, of the second device 2 are omitted in order not to obscure the concepts presented herein.

FIG. 11 is a schematic diagram showing functional modules of a second device according to an embodiment. FIG. 11 schematically illustrates, in terms of a number of functional modules, the components of a second device 2 according to an embodiment. The second device 2 illustrated in FIG. 11 comprises a number of functional modules; a send module 510 configured to send a request for performing an action; an obtain module 520 configured to obtain measurement data; a receive module 530 configured receive measurement data; a send module 540 configured to send measurement data, in particular to the first device 1; and an enable or deny module 550 configured to enable or deny a requested action. The second device 2 of FIG. 11 may further comprise a number of optional functional modules, such as for instance a provide module 550 configured to provide capabilities to a first device and receive a data reduction scheme. In general terms, each functional module 510-550 may be implemented in hardware or in software. Preferably, one or more or all functional modules 510-550 may be implemented by the processing circuitry 410, possibly in cooperation with the communications interface 420 and the storage medium 430. The processing circuitry 410 may thus be arranged to from the storage medium 430 fetch instructions as provided by a functional module 510-550 and to execute these instructions, thereby performing any actions of the second device 2 as disclosed herein.

FIG. 12 shows one example of a computer program product comprising computer readable means according to an embodiment. FIG. 12 shows one example of a computer program product 630 comprising computer readable means 640 according to an embodiment. On this computer readable means 640, a computer program 620 can be stored, which computer program 620 can cause the processing circuitry 410 and thereto operatively coupled entities and devices, such as the communications interface 420 and the storage medium 430, to execute methods according to embodiments described herein. The computer program 620 and/or computer program product 630 may thus provide means for performing any actions of the second device 2 as herein disclosed.

In the example of FIG. 12, the computer program product 630 is illustrated as an optical disc, such as a CD (compact disc) or a DVD (digital versatile disc) or a Blu-Ray disc. The computer program product 630 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 can be stored in any way which is suitable for the computer program product 630.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for confirming proximity of a second device, the method being performed in a first device and both devices being enabled for wireless communication, used for mutual communication, the method comprising:
establishing measurement capabilities of the second device;
obtaining a set of measurement data on local radio characteristics;
receiving measurement data from the second device; and
confirming the second device to be a device in proximity of the first device if the received measurement data matches the obtained set of measurement data.

2. The method as claimed in claim 1, comprising, prior to the obtaining:
determining a data reduction scheme based on the established measurement capabilities, and wherein the obtaining a set of measurement data comprises using the determined data reduction scheme on the measurement data on local radio characteristics.

3. The method as claimed in claim 2, wherein the confirming comprises:
comparing reduced measurement data received from the second device with reduced measurement data obtained in the first device; and
confirming the second device to be in proximity of the first device if the received reduced measurement data matches the reduced measurement data obtained in the first device.

4. The method as claimed in claim 1, wherein the reduced measurement data from the second device comprises results of corresponding measurements as made by the first device to obtain the set of data.

5. The method as claimed in claim 1, wherein the method is initiated by receiving, from the second device a request to perform an action.

6. The method as claimed in claim 5, further comprising determining the second device to be authorized to perform the action when confirmed to be in proximity of the first device.

7. The method as claimed in claim 1, wherein the received measurement data matches the obtained set of data when at least one set threshold is met.

8. The method as claimed in claim 1, wherein the local radio characteristics comprises one or more of: noise floor levels, dynamic range of noise floor to peak level, peak-power, time resolution of signal peaks.

9. The method as claimed in claim 1, further comprising performing an action in response to confirming the second device to being in proximity.

10. The method as claimed in claim 9, wherein the action comprises altering a state of a resource from a first state to a second state.

11. The method as claimed in claim 10, wherein the resource is a lock and one of the first and second states is a locked state and the other an unlocked state; wherein the resource is a device and one of the first and second states is a moving state and the other is a non-moving state.

12. The method as claimed in claim 1, wherein the mutual communication is based on one or both of direct device-to-device, D2D communication and communication via one or more proxy devices in the mutual communication.

13. The method as claimed in claim 1, wherein the wireless communication comprises one or more of: device-to-device, D2D, communication, cellular communication, uplink/downlink Enhanced Mobile Broadband, UL/DL eMBB.

14. A first device configured for confirming proximity of a second device, both devices being enabled for wireless communication, used for mutual communication, the first device being configured to:
establish measurement capabilities of the second device;
obtain a set of measurement data on local radio characteristics;
receive measurement data from the second device; and
confirm the second device to be a device in proximity of the first device if the received measurement data matches the obtained set of measurement data.

15.-20. (canceled)

21. A method for performing a trusted interaction with a first device, the method being performed in a second device and both devices being enabled for wireless communication, used for mutual communication, the method comprising:
receiving, from the first device, a request to measure one or more local radio characteristics and in response thereto performing the requested measuring; and
sending, to the first device, measurement data resulting from the requested measuring.

22. The method as claimed in claim 21, further comprising, prior to receiving the request to measure, providing measurement capabilities to the first device, and receiving in response a data reduction scheme to be used on the measurement data on local radio characteristics.

23. The method as claimed in claim 21, further comprising, prior to receiving the request to measure, sending, to the first device, a request for performing an action, and after sending the measurement data being enabled or denied to perform the action.

24. The method as claimed in claim 21, further comprising receiving, from the first device, instructions to provide a time stamp of the measurement data.

25. The method as claimed claim 21, wherein the wireless communication comprises one or more of: device-to-device, D2D, communication, cellular communication, uplink/downlink Enhanced Mobile Broadband, UL/DL eMBB.

26. A second device for performing a trusted interaction with a first device, the first and second devices being enabled for wireless communication, used for mutual communication, the second device being configured to:
receive, from the first device, a request to measure one or more local radio characteristics and in response thereto performing the requested measuring; and
send, to the first device, measurement data resulting from the requested measuring.

27.-33. (canceled)
